(19) United States
(12) Patent Application Publication
(10) Pub. No.: US 2010/0116149 A1
(43) Pub. Date: May 13, 2010

(54) Flat-top grill heating means

(76) Inventor: Jun-Qing Lai, Taipei (TW)

Correspondence Address: SALLY CHANG, 7F, NO. 3, ALLEY 32, SEC. 6 CHUNG-HSIAO EAST RD., TAIPEI, TAIWAN, R.O.C. 115, TAIPEI, 115, TW

(21) Appl. No.: 12/292,183

(22) Filed: Nov. 13, 2008

(51) Int. Cl. A47J 37/10

(52) U.S. Cl. 99/422

(57) ABSTRACT

A flat-top grill heating means includes a base plate, a convex edge is formed on the bottom side of the base plate along the periphery of which; a convex central block is set in the centre of the area enclosed by said convex edge; a plurality convex heat conducting rings are disposed around said central block on the bottom of said base plate; and a plurality convex heat conducting ribs are disposed around said heat conducting rings; when using the present invention, the base plate is secured to the iron plate of a teppanyaki grill with screws, a gas burner is placed under the bottom of the central block, with installation of central block, heat conducting rings and ribs, heat can be conducted uniformly to the iron plate preventing overheating and charring the center of the iron plate; space enclosed by convex edge can accumulate the hot air, increasing efficacy of heating.

The present invention is related to a heat conducting device for food heating. More specifically, is a spiral heat conducting plate to provide better heat conduction for a Teppanyaki grill.

### DESCRIPTION OF PRIOR ART

A conventional iron plate of a Teppanyaki grill provides function to heat the food but usually it dose not possess very good heat conduction. Without good heat conduction, heat is easily concentrated in one specific area, causing difficulty to control temperature when heating food. Heat concentrated in a specific area will also overheat and char the iron plate making the cleaning of the iron plate an annoying task.

Above-mentioned problems are usually caused by uneven heating, said defects sometimes will deform the iron plate. To solve deformation of iron plate, it usually replaces the thin iron plate with a thicker one. However, adding thickness to the iron plate also increasing the time to heat the iron plate and waste of the gas.

### SUMMARY OF THE INVENTION

The present invention is to improve heat conducting efficiency by installing heat conducting rings and ribs and a heat conducting board to spread the heat uniformly.

To achieve the above-mentioned objectives, a flat-top grill heating means in accordance with the present invention is disclosed. A flat-top grill heating means includes a base plate, a convex edge is formed on the bottom side of the base plate along the periphery of which; a convex central block is set in the centre of the area enclosed by said convex edge; a plurality convex heat conducting rings are disposed around said central block on the bottom of said base plate; and a plurality convex heat conducting ribs are disposed around said heat conducting rings.

Furthermore, heat conducting rings as disclosed in the present invention are disposed in concentric formation around the central block and height between each heat conducting ring is descending towards the outside; said heat conducting ribs are in curved shape and extending towards the inside with same spinning direction, the height between each rib is descending towards the inside. By mentioned placement, heat from heat source will pass upward in a spiral way through heat conducting ribs, heating the iron plate rapidly.

Furthermore, said base plate is a plate of a rectangle and a concave recess is formed on top of the base plate, an air hole is set on one side of said convex edge, two frontal positioning boards are disposed on two ends of the frontal edge of the base plate and two rear positioning boards are disposed on two ends of the rear edge of the base plate.

The flat-top grill heating means has two heat conducting rings and six heat conducting ribs.

A heat conducting board is embedded into said recess.

The efficacy of the present invention is as follows:
1. When the gas burner heats the bottom of the present invention, heat can spread rapidly and uniformly through the convex central block and heat conducting rings placed under the bottom of base plate to the iron plate. The design of curved shape of each heat conducting rib improves heat conduction, whereby heat can transfer equally to the periphery of the iron plate also preventing the overheating and charring of the iron plate.
2. The space enclosed by the convex edge can accumulate the hot air, said accumulating hot air may improve heating efficacy.
3. The design of central block increases the thickness of the base plate, preventing deformation of the base plate when is heated.

### BRIEF DESCRIPTION OF THE DRAWINGS

FIG. 1 is a schematic view of the preferred embodiment of the present invention.

FIG. 2 is a cross sectional view of the preferred embodiment of the present invention along the line I-I.

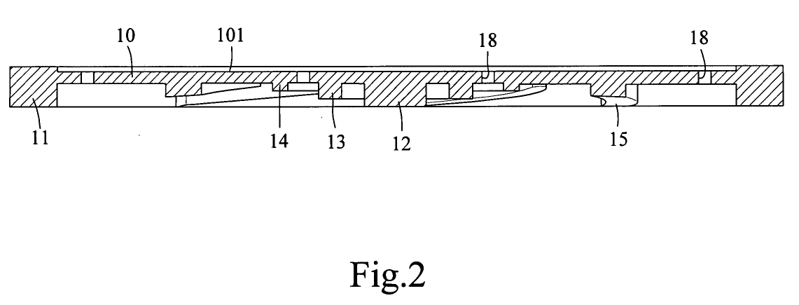

FIG. 3 is a whole cross sectional view of the embodiment of the present invention.

FIG. 4 is a perspective view of the preferred embodiment of the present invention.

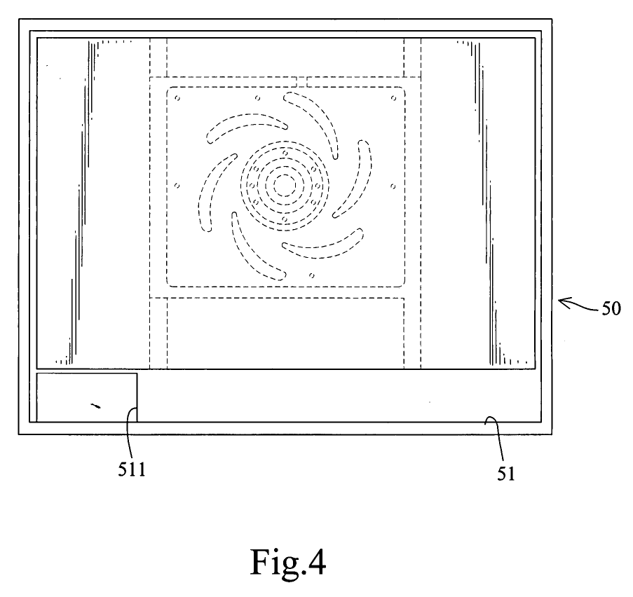

### DETAIL DESCRIPTION OF THE PREFERRED EMBODIMENT OF THE PRESENT INVENTION

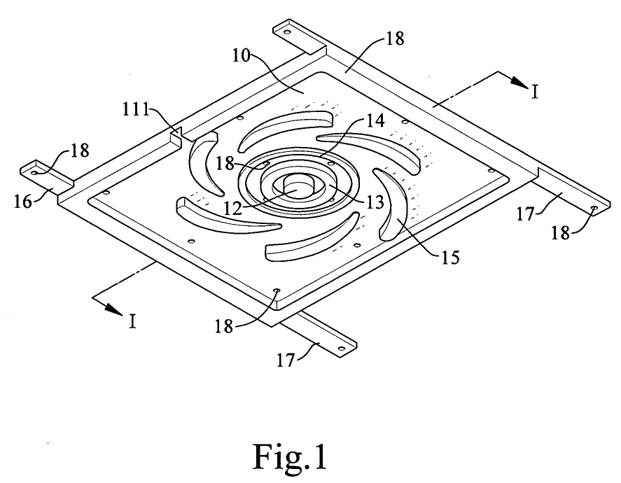

As shown in FIGS. 1˜2, a flat-top grill heating means comprises: a base plate (10), said base plate (10) is a plate of a rectangle and a concave recess (101) is formed on top of the base plate (10), a convex edge (11) is formed on the bottom side of the base plate (10) along the periphery of which; and an air hole (111) is set on center of one side of said convex edge (11);

A convex central block (12) is set in the centre of the area enclosed by said convex edge (11); two convex heat conducting rings (13,14) are disposed around said central block (12) on the bottom of said base plate (10); and six convex heat conducting ribs (15) are disposed around the outer heat conducting rings (14) on the bottom of the base plate (10). Each heat conducting ribs (15) is in curved shape and extending towards the inside with counter-clockwise rotation, the height between each rib is descending towards the inside.

Two frontal positioning boards (16) are disposed on two ends of the frontal edge of said base plate (10) and two rear positioning boards (17) are disposed on two ends of the rear edges of said base plate (10). A screw hole is perforated on each said frontal positioning board (16) and rear positioning board (17), eight screw holes (18) are perforated on said base plate (11) along the periphery of the area enclosed by said convex edge (11), and four screw holes (18) with equal interval are perforated on the base plate (10) between two heat conducting rings (13, 14).

The embodiment predetermines two heat conducting rings (13, 14) can be disposed on the present invention. The number of heat conducting ring (13, 14) can be altered to one or more than three. The number of heat conducting rib (15) is also variable from three, four or more than six. The rotation of each heat conducting rib (15) can be changed either clockwise or counter-clockwise. Changes of number and height of mentioned elements are not limited as the embodiment disclosed.

As shown in FIGS. 1˜3, when utilizing the present invention, a heat conducting board (20) is embedded into a concave inner recess (101), both are fixed under the bottom of the iron plate (30) by screw hole (18) and corresponding fixing element and a gas burner (40) is placed under the central block (12) and the heat conducting rings (13,14).

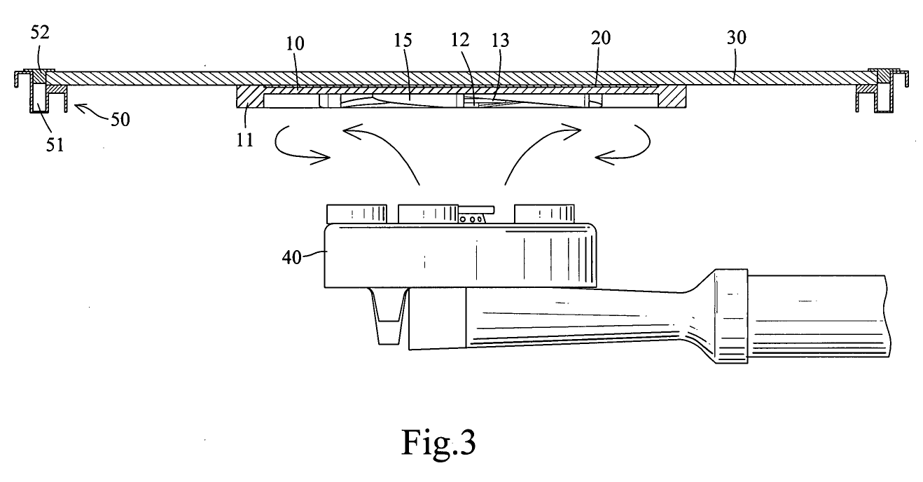

As shown in FIGS. 3˜4, a square supporting frame (50) is disposed on top of the teppanyaki grill, a recess in the center of the supporting frame forms drainage (51) and a water outlet (511) is disposed on the bottom of the frontal side of the said drainage (51). The inner side of the supporting frame (50) is lower than the drainage (51), whereto support the periphery of the bottom of the iron plate (30) and fix the iron plate (30) on the supporting frame (50). A cover strip (52) is disposed on top of the drainage (51) to close said drainage (51).

When the gas burner (40) heats the bottom of the present invention, heat can spread rapidly and uniformly through the convex central block (12) and heat conducting rings (13,14) placed under the bottom of base plate (10) to the iron plate (30). The curved-shaped design and placement of each heat conducting rib (15) improves heat conduction, whereby heat can transfer equally toward the centre of the iron plate (30), preventing the overheating and charring of the iron plate (30).

The space enclosed by the convex edge (11) can accumulate the hot air and expel through the air hole (111) to the outside, said accumulating hot air may improve heating efficacy.

When cleaning the iron plate (30), open the cover strip (52) and sweep the residua on the iron plate (30) to the drainage (51) and collect them from the water outlet which help user to clean the iron plate (30) efficiently.

What is claimed is:

1. A flat-top grill heating means having:
a base plate;
a convex edge, disposed on the bottom side of the base plate along the periphery of which;
a convex central block set in the centre of the area enclosed by said convex edge;
a plurality convex heat conducting rings disposed around said central block on the bottom of said base plate; and
a plurality convex heat conducting ribs are disposed around said heat conducting rings.

2. The flat-top grill heating means of claim 1, wherein said heat conducting rings are disposed in concentric formation around the central block and height between each heat conducting ring is descending towards the outside; said heat conducting ribs are in curved shape and extending towards the inside with counter-clockwise rotation, the height between each rib is descending towards the inside.

3. The flat-top grill heating means of claim 1, wherein two heat conducting rings and six heat conducting ribs are disposed on the bottom of the base plate.

4. The flat-top grill heating means of claim 3, wherein said base plate is a plate of a rectangle and a concave recess is formed on top of the base plate, an air hole is set on one side of said convex edge, two frontal positioning boards are disposed on two ends of the frontal edge of said base plate and two rear positioning boards are disposed on two ends of the rear edge of said base plate.

5. The flat-top grill heating means of claim 4, wherein a screw hole is perforated on each said frontal positioning board and rear positioning board, eight screw holes are perforated on said base plate along the periphery of the area enclosed by said convex edge, and four screw holes with equal interval are perforated on the base plate between two heat conducting rings.

6. The flat-top grill heating means of claim 5, wherein a heat conducting board is embedded into said recess.
